(19) United States
(12) Patent Application Publication
(10) Pub. No.: US 2006/0042015 A1
(43) Pub. Date: Mar. 2, 2006

(54) Fluid-control medical mattress

(76) Inventor: Chao-Jan Wang, Hsinchu (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/927,387

(22) Filed: Aug. 26, 2004

(51) Int. Cl. A61G 7/047; A61G 7/065

(52) U.S. Cl. 5/713; 5/606; 5/933; 5/621

(57) ABSTRACT

A fluid-control medical mattress includes a platform and multiple supports mounted on the platform. Each support is a bladder for selectively receiving fluid to support the patient. A skirt is mounted to a periphery of the platform and the surrounding the platform for retaining water with the platform for a nurse to conveniently clean the body of the patient who lies on the platform. The multiple supports respectively correspond to the head, neck, shoulder, pelvis and knee for supporting the patient who lies on the platform when the multiple supports are full of fluid, and the skirt.

### BACKGROUND OF THE INVENTION

1. Field of the Invention

The present invention relates to a medical mattress, and more particularly to a fluid-control medical mattress.

2. Description of Related Art

A conventional medical mattress in accordance with the prior art comprises multiple parallel longitudinal gasbags arranged to a rectangular structure. The conventional medical mattress can not be partially adjusted the pressure relative to a specific portion of the patient to change the posture of the patient.

When using the conventional medical mattress to a patient who needs a long-term medical care, a nurse is necessary to execute various care to the patient. However, the conventional medical mattress may propagate germs or cause a peculiar smell when being continually used. The conventional medical mattress is unhelpful for a nurse to execute various care to the patient.

The present invention has arisen to mitigate and/or obviate the disadvantages of the conventional medical mattress.

### SUMMARY OF THE INVENTION

The main objective of the present invention is to provide an improved medical mattress that is fluid-control and can support the patient for nurse to conveniently clean the patient's body.

To achieve the objective, the fluid-control medical mattress in accordance with the present invention comprises a platform and multiple supports mounted on the platform. Each support is a bladder for selectively receiving fluid to support the patient. A skirt is mounted to a periphery of the platform and the surrounding the platform for retaining water with the platform for a nurse to conveniently clean the body of the patient who lies on the platform. The multiple supports respectively correspond to the head, neck, shoulder, pelvis and knee for supporting the patient who lies on the platform when the multiple supports are full of fluid, and the skirt.

Further benefits and advantages of the present invention will become apparent after a careful reading of the detailed description with appropriate reference to the accompanying drawings.

### BRIEF DESCRIPTION OF THE DRAWINGS

FIG. 1 is a top plan view of a fluid-control medical mattress in accordance with the present invention;

FIG. 2 is a perspective view of the fluid-control medical mattress in accordance with the present invention;

FIG. 3 is a side plan view of the fluid-control medical mattress in FIG. 2;

FIG. 4A is a perspective view of the support of the present invention when being full of fluid;

FIG. 4B is a perspective view of the support of the present invention when the fluid in the support is drained;

FIG. 5 is a perspective view of the fluid-control medical mattress of the present invention when retaining water;

FIG. 6 is a second side plan view of the fluid-control medical mattress when the massage device in mounted;

FIG. 7 is a perspective view of the massage device in FIG. 6;

FIG. 8A is a first operational view of the clapper of the massage device in FIG. 7;

FIG. 8B is a second operational view of the clapper of the massage device in FIG. 7;

FIG. 9 is a perspective view of the valve of the fluid-control medical mattress in accordance with the present invention;

FIG. 10 is a top plan view of the control device of the fluid-control medical mattress in accordance with the present invention; and

FIG. 11 is an electric connect diagram of the fluid-control medical mattress in accordance with the present invention.

### DETAILED DESCRIPTION OF THE INVENTION

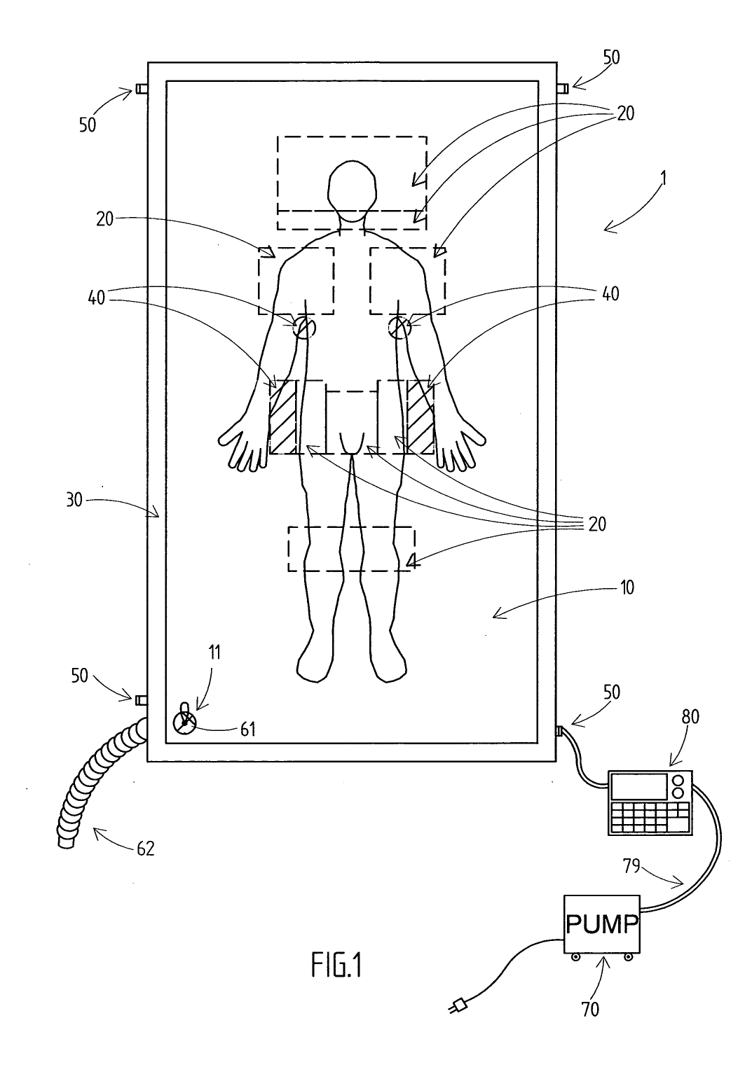

Referring to the drawings and initially to FIG. 1, a fluid-control medical mattress (1) in accordance with the present invention comprises a platform (10) for patient to lie thereon, multiple supports (20) mounted on the platform (10) for supporting the patient, one for head, one for neck, two for shoulder, two for pelvis, one for buttocks and one for knees, a skirt (30) upwardly extending from an periphery of the platform (10) for containing water and multiple stoppers (40) situated on patient's axillas and two side of the pelvis when the patient lies.

In the preferred embodiment of the present invention, the platform (10) is a thin bladder for selectively containing fluid.

Each support (20) is a bladder for containing fluid and has a size corresponding to the positions of the patient. Some of the supports (20), for the patient's head, neck and knees, has a concave defined in a top thereof for anti-slip. Some of the supports (20), for patient's shoulder and pelvis, have multiple cubic or cylindrical protrusions upwardly extending from a top thereof for promoting friction. The support (20), for patient's buttocks can lift the patient's buttocks for nurse to easily clean patient's anus.

The skirt (30) is a loop of bladder for containing fluid and surrounding the platform (10). The skirt (30) forms an endless wall after containing fluid for retaining water such that the nurse can conveniently clean patient's body.

Each stopper (40) is a bladder for containing fluid and prevents the patient from a lateral movement when the multiple stoppers (40) contains fluid and expands.

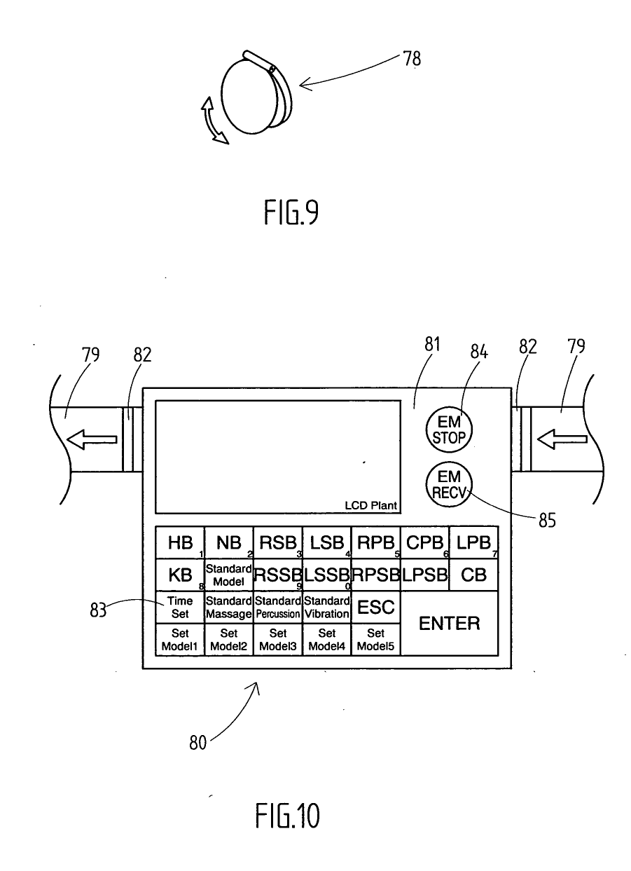

The platform (10), the multiple supports (20) and the multiple stoppers (40) can communicate with one another via multiple paths (not shown). Multiple valves (78), as shown in FIG. 9, are mounted among the platform (10), the multiple supports (20) and the multiple stoppers (40) for selectively separating the platform (10), the multiple supports (20) and the multiple stoppers (40) from one another.

With reference to FIG. 1, the platform (10) includes multiple joints (50) mounted to an outer periphery thereof and communicating with inner peripheries of the platform (10), the multiple supports (20) and the multiple stoppers (40) for guiding fluid into the platform (10), the multiple supports (20) and the multiple stoppers (40). A first outlet (11) is defined in a bottom of the platform (10) and a first block (61) is securely received in the first outlet (11) for selectively opening the first outlet (11). An exhaust tube (62) is mounted to the platform (10) and communicates with the first outlet (11) in the platform (10). A recess (12) is defined in the bottom of the platform (10) corresponding to the buttocks of the patient who lies on the platform (10). The recess (12) retains water for nurse to conveniently clean the patient's anus. A second outlet (13) is defined in a bottom of the recess (12) for exhausting the dirty water and a second block (63) is selectively securely received in the second outlet (13) for closing the second outlet (13).

The fluid-control medical mattress (1) is operated with a pump (70) for pumping the fluid into the platform (10), the multiple supports (20) and the multiple stoppers (40) via a tube (79) that is connected to the pump (70) and a corresponding one of the multiple joints (50). The pump (70) is a hydraulic pump or a pneumatic pump. A control device (80) is electrically connected to the pump (70) for operating the pump for controlling the pressure in the platform (10), the multiple supports (20) and the multiple stoppers (40).

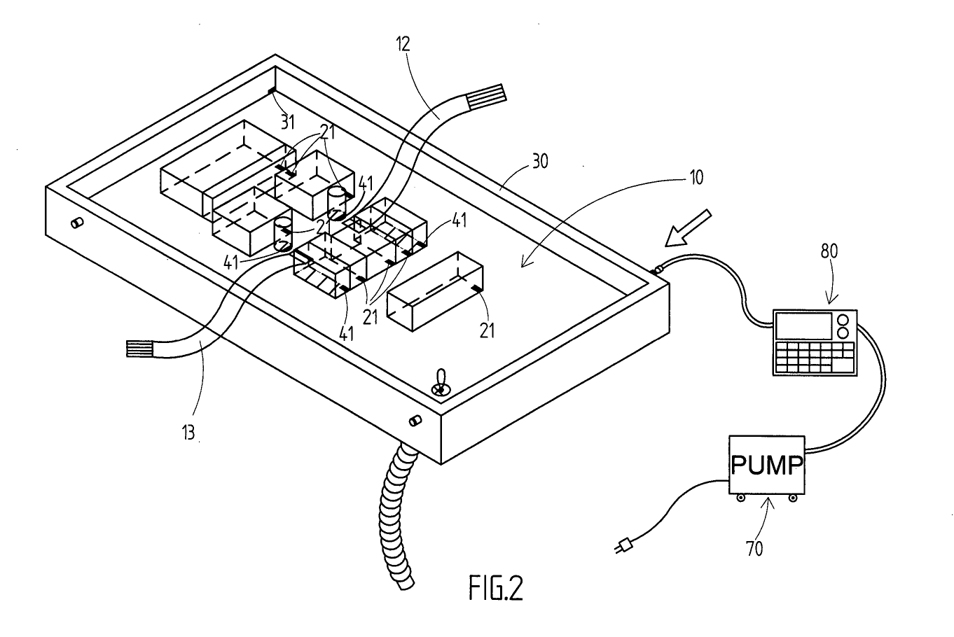

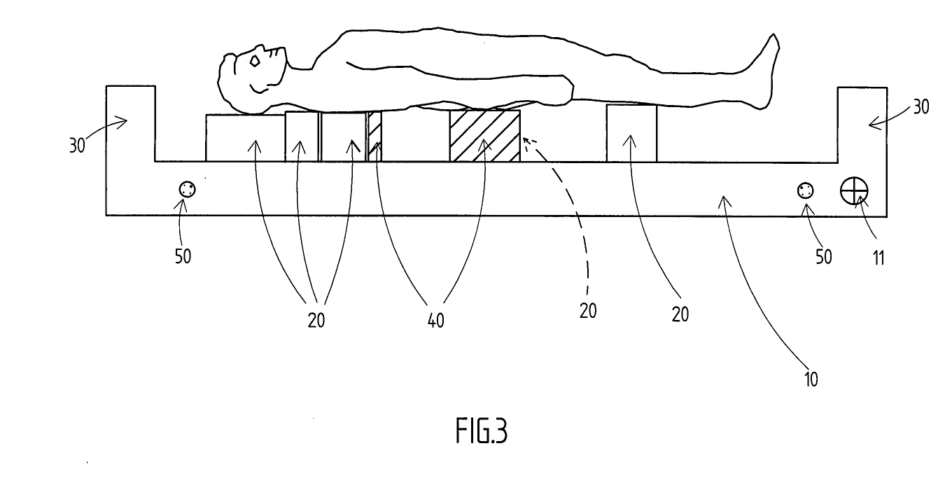

With reference to FIGS. 2 and 3, the platform (10) includes a first belt (14) and a second belt (15) each having a first end secured on the platform (10) and a second end selectively connected to each other to further position the patient on the platform (10).

Each support (20), stopper (40) and the skirt (30) has a sensor (21, 41, 31) secured thereon and electrically connected to the control device (80) for sensing the pressure in each of the supports (20), the stoppers (40) and the skirt (30) to start/stop the pump (70).

The platform (10) and the skirt (30) can retain water when the platform (10), the multiple supports (20), the skirt (30) and the multiple stoppers (40) are full of fluid.

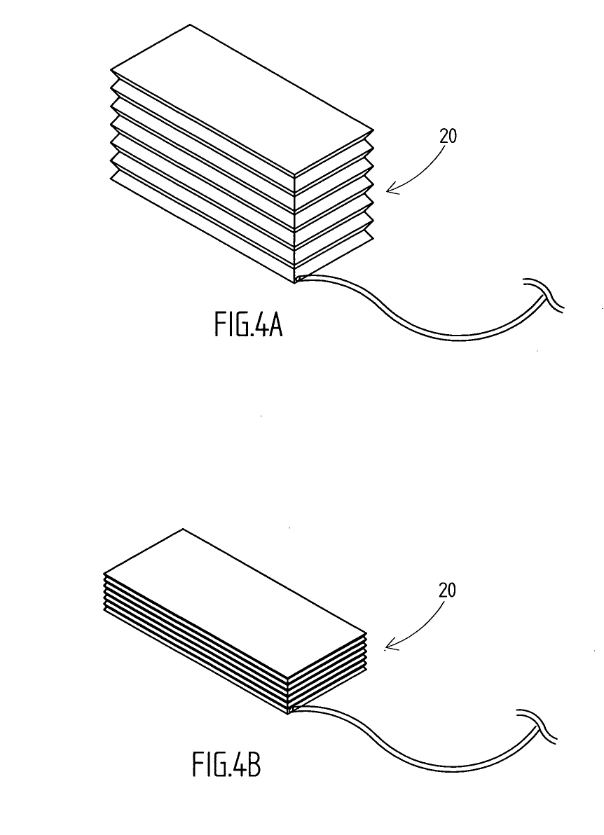

With reference to FIGS. 4A and 4B, each support (20) has a series of crepe structures that expand to support the patient's body when the fluid is full of each of the support and piled on another when the fluid in each of the support is exhausted.

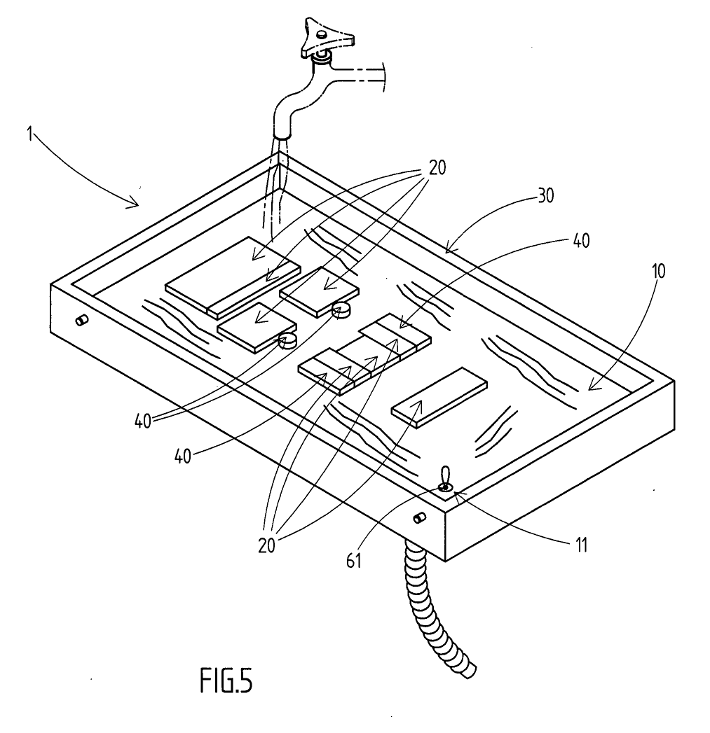

With reference to FIG. 5, the first outlet (11) and the second outlet (13) are respectively blocked by the first block (31) and the second block (63), and the skirt (30) is full of fluid to form an endless wall for retaining water. Furthermore, the fluid in each support (20) and the stopper (40) is exhausted such that the patient lies on the platform (10). Then, the nurse can clean the patient by using the water retained within the skirt (30) and pull the first block (61) for draining the dirty water after cleaning the patient's body and using the water in the recess (12) to clean the patient's anus. Finally, the second block (63) is pulled to draining the water in the recess (12).

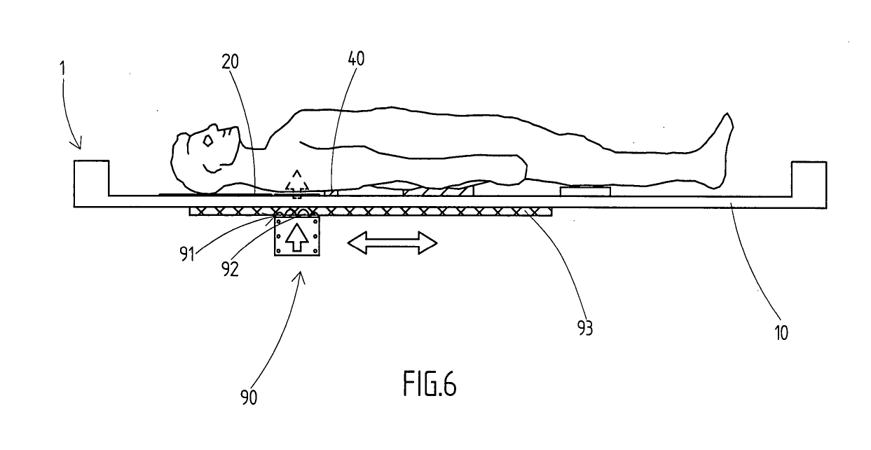

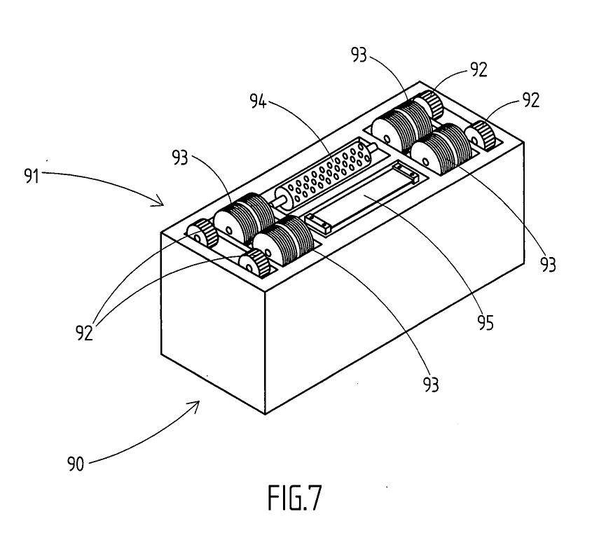

With reference to FIGS. 6 and 7, the fluid-control medical mattress (1) in accordance with the present invention further comprises a massage device (90) mounted to a lower side of the platform (10). The massage device (90) includes a drive device (not shown) mounted therein and an actuated device (91) partially extending out of the massage device (90). The actuated device (91) includes multiple teethed wheels (92) each engaged to a rail (93) that is mounted on the lower side of the platform (10) such that the massage device (90) is reciprocally moved relative to the platform (10). The massage device (90) includes multiple massage rollers (94) and a cylinder (95) with series boss (not numbered) partially extending out of the massage device (90) for massage the patient's back when the massage device (90) is reciprocally moved relative to the platform (10) and the fluid in the platform (10), the supports (20) and the stoppers (40) is exhausted.

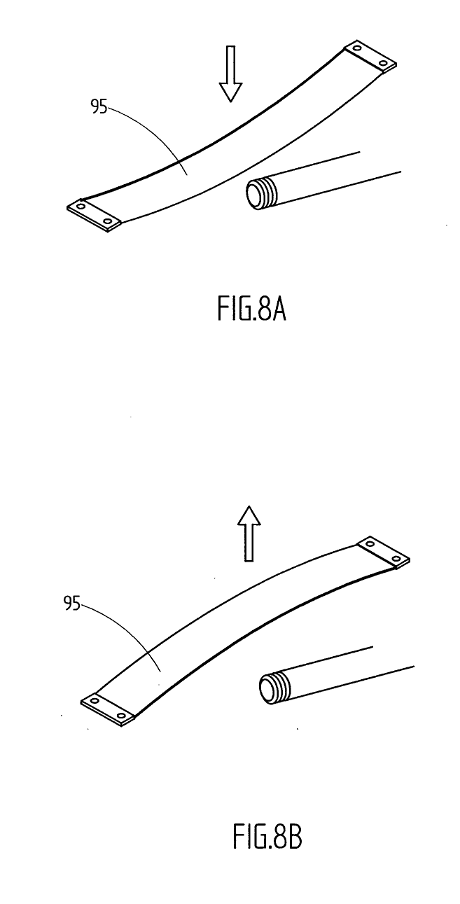

With reference to FIGS. 7, 8A and 8B, the massage device (90) further includes a flexible clapper (96) mounted on a top of the massage device (70) and corresponding to the lung of the patient when lying on the platform (10). The flexible clapper (96) is actuated by an electromagnet or a cam set and reciprocally smoothly slaps the back of the patient for reducing phlegm.

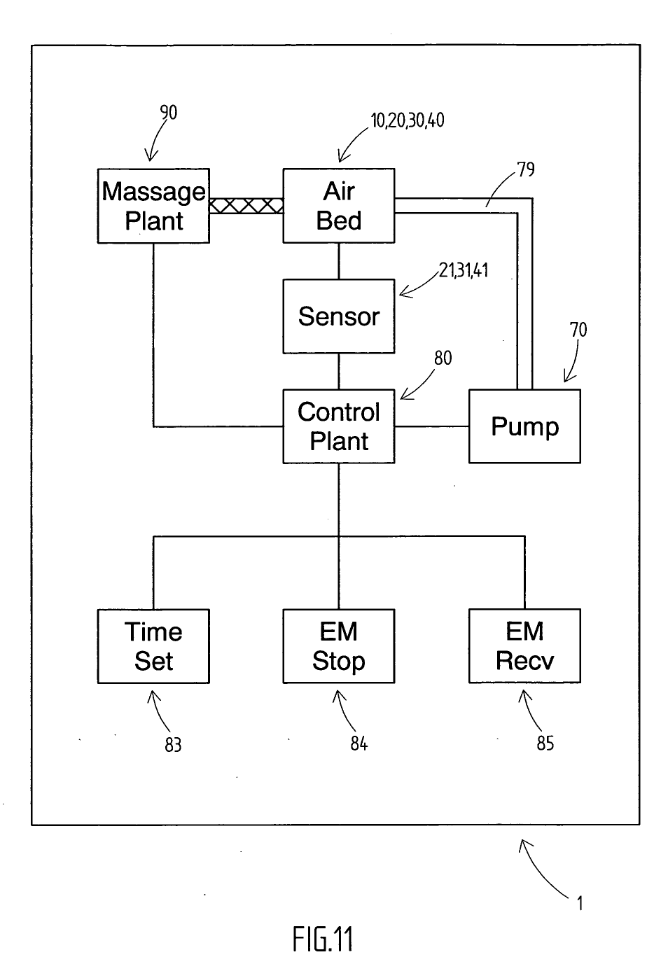

With reference to FIGS. 10 and 11, the control device (80) is electrically connected to the pump (70) and the massage device (90), and includes a control unit (81) mounted therein and including a control panel and electric circuit. Two control valves (82) are mounted to two opposite sides of control device (80) and respectively communicating with the tube (79) to selectively close the tube (79) for controlling the pressure in the platform (10), the supports (20), the skirt (30) and the stoppers (40). The valve and the control valve (82) is a check valve. The control device (80) includes a time calculator (83) for controlling the operating time of the drive device of the massage device (90), the valves (78) and the control valves (82). The control device (80) includes an emergent button (84) mounted on the panel (81). The pump (70) and the massage device (90) are immediately stopped when the emergent button (84) is pressed. The control device (80) includes an emergent recovery button (85) mounted on the panel (81). The pump (70), the massage device (90) are immediately stopped and the fluid in the platform (10), the supports (20), the skirt (30) and the stoppers (40) is exhausted in seconds for doctor to take a first aid to the patient when the emergent recovery button (85) is pressed.

Although the invention has been explained in relation to its preferred embodiment, it is to be understood that many other possible modifications and variations can be made without departing from the spirit and scope of the invention as hereinafter claimed.

What is claimed is:

1. A fluid-control medical mattress comprising:
a platform;
multiple supports mounted on the platform, each support being a bladder for selectively receiving fluid and adapted to support the patient; and
a skirt mounted to a periphery of the platform and the surrounding the platform;
wherein the improvement comprises:
the multiple supports respectively correspond to the head, neck, shoulder, pelvis and knee for supporting the patient who lies on the platform when the multiple supports are full of fluid, and the skirt retains water with the platform for a nurse to conveniently clean the body of the patient who lies on the platform.

2. The medical mattress as claimed in claim 1, wherein the platform comprises two belts each having a first end secured on the platform and a second end selectively connected to each other for position the patient who lies on the platform.

3. The medical mattress as claimed in claim 1, wherein the platform comprises a first outlet defined in the platform for draining the water after cleaning and a first block selectively securely received in the first outlet for retaining water within the skirt.

4. The medical mattress as claimed in claim 1, wherein the platform comprises a recess defined therein and corresponding to the buttocks of the patient who lies on the platform, the recess retaining water for a nurse to conveniently clean the patient's anus, a second outlet is defined in a bottom of the recess for draining water after cleaning and a second block selectively securely received in the second outlet for retaining water.

5. The medical mattress as claimed in claim 1, wherein the skirt is a bladder and forms an endless wall for retaining water when being full of fluid.

6. The medical mattress as claimed in claim 5 further comprising multiple stoppers each being a bladder for containing fluid, the multiple stoppers situated on patient's axillas and two side of the pelvis when the patient lies on the platform.

7. The medical mattress as claimed in claim 6, wherein the platform, the multiple supports, the skirt and the stoppers communicate with one another via paths, and multiple valves are mounted in the paths to selectively separate the platform, the multiple supports, the skirt and the stoppers from one another.

8. The medical mattress as claimed in claim 7, wherein each valve is a check valve.

9. The medical mattress as claimed in claim 7, wherein the platform comprises multiple joints mounted to a periphery thereof and communicating with the paths among the platform, the multiple supports, the skirt and the stoppers.

10. The medical mattress as claimed in claim 9 further comprising a tube connected to a corresponding one of the multiple joints for transmitting fluid into the platform, the multiple supports, the skirt and the stoppers.

11. The medical mattress as claimed in claim 10 further comprising a pump communicating with the tube for pumping the fluid into the platform, the multiple supports, the skirt and the stoppers.

12. The medical mattress as claimed in claim 11 further comprising a control device electrically connected to the pump and the valves for controlling the pressure in the platform, the multiple supports, the skirt and the stoppers.

13. The medical mattress as claimed in claim 12, wherein the control device comprises a time calculator mounted therein for control the operating time of the pump and the valves.

14. The medical mattress as claimed in claim 12, wherein each support, each stopper and the skirt respectively have a sensor secured thereon and respectively electrically connected to the control device for sensing the pressure in each of the multiple supports, the multiple stoppers and the skirt to start/stop the pump.

15. The medical mattress as claimed in claim 12, wherein the control device comprises an emergent button mounted on a panel thereof, the pump and the massage device being immediately stopped when the emergent button is pressed.

16. The medical mattress as claimed in claim 13, wherein the control device comprises an emergent recovery button mounted on a panel thereof, the pump and the massage device being immediately stopped and the fluid in the platform, the supports, the skirt and the stoppers is exhausted in seconds for doctor to take a first aid to the patient when the emergent recovery button is pressed.

17. A fluid-control medical mattress comprising:
a platform;
multiple supports mounted on the platform, each support being a bladder for selectively receiving fluid and adapted to support the patient;
a skirt mounted to a periphery of the platform and the surrounding the platform; and
a massage device mounted to a lower side of the platform, the massage device includes a drive device mounted therein and an actuated device partially extending out of the massage device;
wherein the improvement comprises:
the multiple supports respectively correspond to the head, neck, shoulder, pelvis and knee for supporting the patient who lies on the platform when the multiple supports are full of fluid, and the skirt retains water with the platform for a nurse to conveniently clean the body of the patient who lies on the platform, the massage device reciprocally moved relative to the platform, the drive device of the massage device driving the actuated device that contacts with patient's back via the platform.

18. The medical mattress as claimed in claim 17, wherein the actuated device of the massage device includes multiple teethed wheels each engaged to a rail that is mounted on the lower side of the platform such that the massage device is reciprocally moved relative to the platform, and the massage device includes multiple massage rollers and a cylinder with series boss partially extending out of the massage device for massaging the patient's back when the massage device is reciprocally moved relative to the platform and the fluid in the platform, the supports and the stoppers is exhausted.

19. The medical mattress as claimed in claim 17 further comprising a control device electrically connected to the massage device for controlling massage device.

20. The medical mattress as claimed in claim 19, wherein the control device comprises a time calculator mounted therein for control the operating time of the massage device.

21. The medical mattress as claimed in claim 19, wherein the control device comprises an emergent button mounted on a panel thereof, the massage device being immediately stopped when the emergent button is pressed.

22. The medical mattress as claimed in claim 19, wherein the control device comprises an emergent recovery button mounted on a panel thereof, the massage device being immediately stopped and the fluid in the platform, the supports, the skirt and the stoppers is exhausted in seconds for doctor to take a first aid to the patient when the emergent recovery button is pressed.
